(19) United States
(12) Patent Application Publication
(10) Pub. No.: US 2026/0111181 A1
(43) Pub. Date: Apr. 23, 2026

(54) IMAGE-TO-HTML USING MACHINE VISION

(71) Applicant: Micro Focus LLC, Wilmington, DE (US)

(72) Inventors: Bin Li, Shanghai (CN); Bin Zhou, Shanghai (CN); Rex Jiang, Shanghai (CN)

(73) Assignee: Micro Focus LLC, Wilmington, DE (US)

(21) Appl. No.: 18/919,636

(22) Filed: Oct. 18, 2024

(51) Int. Cl. G06F 8/34; G06F 11/36

(52) U.S. Cl. CPC G06F 8/34; G06F 11/3684

(57) ABSTRACT

Automating testing or use of an application under test (AUT) is greatly simplified when domain object model (DOM) information is available. However, DOM information is not always available. Systems and methods are provided wherein graphical elements are identified and converted to computer code. The computer code is applied to a transparent layer and as a user visually interacts with the AUT, the transparent layer identifies the inputs and the root graphical elements. The inputs are then forwarded to the root graphical elements. The inputs and target graphical elements may be recorded and played back (as-is or modified) on the same or different AUT. The playback then allows a specific graphical element to receive a particular input, even if DOM information remains unavailable.

### FIELD OF THE DISCLOSURE

The invention relates generally to systems and methods for identifying graphical elements of a user interface and particularly to using computer vision to identify graphical elements.

### BACKGROUND

Testing software applications is impractical and often impossible for human testers to perform. The combination of options, platforms, and inputs make even the simplest applications have a near infinite number of options. As a result, applications are rarely exhaustively tested by a human operator. Automated testing applications allows for greater flexibility and resilience in the testing environment to ensure all tests that need to be performed are accurately performed.

Testing a software application commonly requires automating inputs and outputs via accessing a software application's Domain Object Model (DOM) structure. For example, a testing application may execute a test and determine that an “onclick” event may be performed on an object and generate a mouse click input to the object.

### SUMMARY

Having access to an application's DOM objects is not always possible. For example, a game may be presented as a single graphical element but may have discrete areas having specific functions. Prior art tools may be able to tell that a user selected “something” at a particular location on the display, but be unable to identify the particular target of the input. A human tester may see that a graphical user interface (GUI) presents selectable areas, however, without DOM information, an automated testing application cannot determine interactive objects within the GUI. Being able to determine that an input was received to the entire display is of limited value. However, being able to determine the specific location of a graphical element that is the subject of a user input allows the application under test (AUT) to be tested even without access to DOM information. When a user, via a mouse, touch screen, or other pointer, clicks on a portion of the GUI, the application determines the location of the click and the associated action at that location. As a result, the user's actions may be captured and processed, such as an input to the generation of a test script.

While an automated system may determine that a particular action is associated with a particular location, such tests are often not repeatable except when using the same hardware and configurations. For example, a testing application may see that a click at location 100, 100 performs an action, which may be later determined; yet the application, when ported to a different operating system or different display configuration, may not be reproducible.

These and other needs are addressed by the various embodiments and configurations of the present invention. The present invention can provide a number of advantages depending on the particular configuration. These and other advantages will be apparent from the disclosure of the invention(s) contained herein.

In some aspects, the techniques described herein relate to a method, including: accessing an application, the application including a graphical user interface (GUI) including a plurality of graphical elements; capturing an image of the GUI; visually identifying each of the plurality of graphical elements of the GUI; converting the image into computer code to imitate each of the plurality of graphical elements; generating a first transparent mask over the GUI; rendering the computer code on the first transparent mask; receiving an input to the first transparent mask; and determining a root graphical element associated with a first graphical element corresponding to one of the plurality of graphical elements co-located with the first input.

In some aspects, the techniques described herein relate to a method, further including: rendering the computer code including a second transparent mask; receiving a second input to the second transparent mask; generating an event corresponding to the second input to the second transparent mask; visually identifying a target graphical element associated with the one of the plurality of graphical elements co-located with the second input.

In some aspects, the techniques described herein relate to a method, further including providing the target graphical element with the event corresponding to the second input to the second transparent mask.

In some aspects, the techniques described herein relate to a method, wherein: visually identifying each of the plurality of graphical elements further includes identifying a plurality of sub-elements including at least one of the plurality of graphical elements; and determining the root graphical element associated with the one of the plurality of graphical elements co-located with the first input, further includes, determining a sub-root graphical element associated with the one of the plurality of sub-elements.

In some aspects, the techniques described herein relate to a method, wherein the identifying the plurality of graphical elements includes providing the GUI to a neural network trained to identify graphical elements and receiving, therefrom, a description of the plurality of graphical elements.

In some aspects, the techniques described herein relate to a method, further including providing at least one attribute of the first input to the neural network.

In some aspects, the techniques described herein relate to a method, wherein the computer code includes a hypertext markup language (HTML) code snippet.

In some aspects, the techniques described herein relate to a method, wherein the application includes a web browser configured with instructions to present the GUI.

In some aspects, the techniques described herein relate to a method, further including, generating a test script including at least one test input corresponding to the first input to the one of the plurality of graphical elements co-located with the first input.

In some aspects, the techniques described herein relate to a method, wherein generating the test script further includes generating the at least one test input including modification, the modification including at least one of generating the at least one test input to differ from the first input, generating the at least one test input to be applied to a second one of the plurality of graphical elements co-located with the first input, or generating an additional test input to be performed before or after the test input.

In some aspects, the techniques described herein relate to a system, including: a microprocessor coupled to instructions maintained in a non-transitory memory that, when read by the microprocessor, cause the microprocessor to perform: accessing an application, the application including a graphical user interface (GUI) including a plurality of graphical elements; capturing an image of the GUI; visually identifying each of the plurality of graphical elements; converting the image into computer code to imitate each of the plurality of graphical elements; generating a first transparent mask to the GUI; rendering the computer code on the first transparent mask; receiving an input to the first transparent mask; and determining a root graphical element associated with a first graphical element corresponding to one of the plurality of graphical elements co-located with the first input.

In some aspects, the techniques described herein relate to a system, further including instructions to cause the microprocessor to perform: rendering the computer code including a second transparent mask; receiving a second input to the second transparent mask; generating an event corresponding to the second input to the second transparent mask; visually identifying a target graphical element associated with the one of the plurality of graphical elements co-located with the second input.

In some aspects, the techniques described herein relate to a system, further including instructions to cause the microprocessor to perform providing the target graphical element with the event corresponding to the second input to the second transparent mask.

In some aspects, the techniques described herein relate to a system, further including instructions to cause the microprocessor to perform: visually identifying each of the plurality of graphical elements further includes identifying a plurality of sub-elements including at least one of the plurality of graphical elements; and determining the root graphical element associated with the one of the plurality of graphical elements co-located with the first input, further includes, determining a sub-root graphical element associated with the one of the plurality of sub-elements.

In some aspects, the techniques described herein relate to a system, wherein the instructions to cause the microprocessor to perform identifying the plurality of graphical elements further includes instructions to cause the microprocessor to perform providing the GUI to a neural network trained to identify graphical elements and receiving, therefrom, a description of the plurality of graphical elements.

In some aspects, the techniques described herein relate to a system, further including instructions to cause the microprocessor to perform providing at least one attribute of the first input to the neural network.

In some aspects, the techniques described herein relate to a system, wherein the computer code includes a hypertext markup language (HTML) code snippet.

In some aspects, the techniques described herein relate to a system, wherein the application includes a web browser configured with instructions to present the GUI.

In some aspects, the techniques described herein relate to a system, further including instructions to cause the microprocessor to perform generating a test script including at least one test input corresponding to the first input to the one of the plurality of graphical elements co-located with the first input.

In some aspects, the techniques described herein relate to an apparatus, including: a network interface to a network; a storage device; and at least one microprocessor each of the at least one microprocessor coupled to a non-transitory memory including instructions that, when read by the at least one microprocessor, cause at least a portion of the at least one microprocessor to perform: executing an application, the application including a graphical user interface (GUI) including a plurality of graphical elements; capturing an image of the GUI; visually identifying each of the plurality of graphical elements; converting the image into computer code to imitate each of the plurality of graphical elements; generating a first transparent mask to the GUI; rendering the computer code on the first transparent mask; receiving an input to the first transparent mask; determining a root graphical element associated with a first graphical element corresponding to one of the plurality of graphical elements co-located with the first input; generating a test script including at least one test input corresponding to the first input to the one of the plurality of graphical elements co-located with the first input; and providing the test script to at least one of the storage device or a second device via the network interface.

A system on a chip (SoC) including any one or more of the above aspects or aspects of the embodiments described herein.

One or more means for performing any one or more of the above or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects or aspects of the embodiments described herein, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a process in accordance with embodiments of the present disclosure;

FIG. 3 depicts a process in accordance with embodiments of the present disclosure; and

FIG. 4 depicts a device in a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

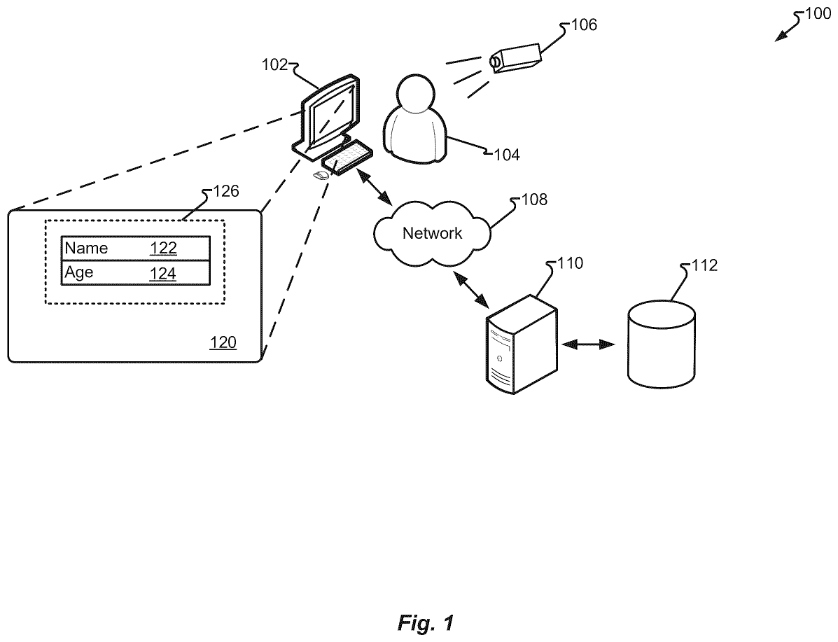

FIG. 1 illustrates system 100 in accordance with embodiments of the present disclosure. In one embodiment, system 100 illustrates components comprising computing components, such as computer 102 and server 110, and data storage components, such as data storage 112 interconnected, such as via network 108. It should be appreciated that, in one embodiment, each of the illustrated components provides a single service. However, one of ordinary skill in the art will recognize that other topologies may be deployed without departing from the scope of embodiments herein. For example, any one component may be embodied as a plurality of components and/or any two or more components may be embodied as a single component. In one embodiment, the components as illustrated perform a single function; in other embodiments, one or more components may perform a plurality of functions and/or one or more functions may be performed by a plurality of components including as a service (e.g., software as a service (SaaS)). In yet another embodiment, the connection topology may be the topology as illustrated in system 100 or another topology without departing from the scope of the embodiments.

In one embodiment, computer 102 executes an application under test (AUT) (not shown). It should be appreciated that computer 102, while illustrated as a personal computer, may be a cellular telephone, laptop computer, tablet computer, game, or other computing device operable to execute the AUT. Computer 102 presents GUI 120 having one or more graphical elements, such as first graphical element 122 and second graphical element 124. It should be appreciated that GUI 120 may comprise one or more graphical elements and that any one or more of the graphical elements may be of a different type such as to present information, such as text and/or graphic, and/or receive inputs (e.g., text box, radio button, check box, slider, etc.).

In another embodiment, graphical element 126 may receive an event which is then further used to determine a particular subelement receiving the event, such as first graphical element 122 or second graphical element 124. As a result, graphical elements may be nested, such as form having a number of data entry objects and/or selectable options which may, in turn, have their own data entry objects and/or selectable options.

Server 110 comprises one or more microprocessors and receives a visual image of GUI 120. The image of GUI 120 may be received by camera 106 or via a wired/wireless network, which may form a portion of network 108 and/or a different network. Additionally or alternatively, server 110 may receive GUI 120 as an output of computer 102 (e.g., a monitor output, memory probe, etc.). As a result, server 110 receives a visual representation of the AUT similar to what is presented to user 104. However, it should be appreciated that user 104 may be a human user or an automated user providing direct inputs (e.g., a generated keyboard, mouse, signals, etc.) to computer 102 and receiving visual information via a camera and/or video output from computer 102.

Server 110 (or one or more microprocessors thereof) visually identifies each graphical element, such as first graphical element 122 and second graphical element 124 of GUI 120. Visual identification of the graphical element(s) is variously embodied. In one embodiment, GUI 120 is provided to an artificial intelligence (AI), such as one executing on server 110 and/or other computing device. The AI is trained to receive GUI images and identify the corresponding graphical elements. In another embodiment, identification comprises identifying a number of sub-elements. For example, first graphical element 122 presents text (“Name”) as one sub-element and an input box, as a second sub-element. Accordingly, the text may be determined to be a prompt and, upon receiving a keyboard input, text is provided by the keyboard input and the original text (“Name”) removed. As a result, first graphical element 122 may be identified as a text input box. Additionally or alternatively, first graphical element 122 may be further identified as a request for specific text (i.e., a name).

In another embodiment, server 110 generates a transparent mask (not shown) over GUI 120. The transparent mask is applied (visually) on top of GUI 120. As a result, an input to any graphical element of GUI 120 is to the transparent mask.

The input to the transparent mask is processed, such as to identify the location of an input (e.g., where text was entered, the target of a mouse click event, etc.), and the event forwarded to the corresponding graphical element of the AUT. As a result, the AUT receives inputs from 104 and operates as if the transparent mask were not applied. Additionally or alternatively, identifying the location of the input on the transparent mask further determines the graphical element, such as an asset name or other identifier. The asset name may be generated (e.g., “text_input_01”, etc.).

In another embodiment, computer code is generated, such as HTML, to imitate each of the graphical elements (e.g., graphical element 122, graphical element 124, etc.). The generated code may then perform one or more of visually drawing the graphical elements, such as on the transparent layer, receiving a user input, presenting a graphical element state change (e.g., checking/unchecking a checkbox, displaying inputted text, etc.), displaying data received from the AUT, etc.

In another embodiment, the computer code is rendered on to the transparent layer and, as a result, an input to GUI 120 is received by the transparent layer and the target of the input may be determined as an input to a particular graphical element, such as a discrete object (e.g., a button, tab, checkbox, etc.) or as a portion of a graphical element (e.g., a selection of a character in a game, city on a map, component of a machine, etc.).

In another embodiment, a test script may be generated to reproduce the features of GUI 120 on another AUT and reply, modified or unmodified, versions of the test script to test the other AUT, such as to test the other AUT on a different platform, test different user inputs, etc.

In yet another embodiment, a saved (and optionally modified) script in data storage 112 from a prior interaction may be applied to an AUT. For example, server 110 may apply the transparent layer to GUI 120 and generate the computer code to reproduce the graphical elements therein. Inputs may then be generated/played back off the computer code on the transparent layer, and are then provided to the root graphical element of the AUT as if they were an input from user 104.

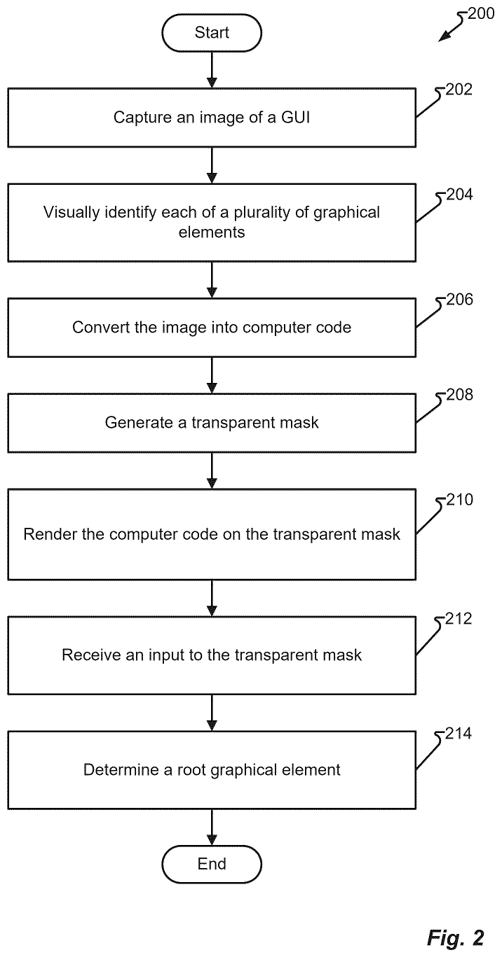

FIG. 2 depicts a process in accordance with embodiments of the present disclosure. In one embodiment, process 200 is embodied as machine-readable instructions maintained in a non-transitory memory that when read by a machine, such as one or more microprocessors of a server or servers, cause the machine to execute the instructions and thereby execute process 200. The processor of the server may include, but is not limited to, at least one microprocessor of server 110.

In one embodiment, process 200 begins and, at step 202 an image of a GUI is captured, such as GUI 120 being captured by computer 102, camera 106, etc., and provided to a data processing component, such as server 110. The image may be a single image or a plurality of images (e.g., a set of periodic still images, a video image, etc.). Step 204 visually identifies one, and preferably all, graphical elements in the image. Notably, step 204 excludes accessing DOM object information for the graphical elements and instead relies entirely on the visual presentation of the AUT, namely the GUI.

Step 204 may comprise providing the image to an AI trained or otherwise configured to identify graphical elements. For example, a neural network may be trained with a set of prior images. The set of prior images may be transformed to create a modified set of prior images. The transformation may include one or more of changing one or more colors, adding redundant elements, removing redundant elements, adding text, removing text, altering text, and altering the placement of graphical elements. A first training set is then created comprising the set of prior images and the modified set of prior images. The neural network is then trained in a first training stage with the first training set. A second training set is then created comprising the first set of prior images, the modified set of prior images, and a set of images having graphical elements incorrectly identified in the first training stage as a graphical element. Then the neural network is trained in a second training stage with the second training set.

In another embodiment, step 204 may comprise providing an AI with a set of known graphical images, the image captured in step 202, and a prompt to identify graphical images in the image captured in step 202.

Next, step 206 converts the image into computer code, such as HTML. Step 206 may comprise accessing code snippets to perform user-interface actions, such as select an object, receive text, etc. Step 208 generates a transparent mask and, in step 210, renders the computer code on the transparent mask. The mask is applied, such as in computer code, to be visually on top of the AUT. As a result, a user input to the AUT is intercepted by the transparent mask. Step 212 receives such an input and identifies the root graphical element of the AUT and forwards the input to the root graphical element. As a result, an input to the transparent mask executes the computer code, forwards the input to the root graphical element, and thereby imitates the graphical element and the behavior thereof as if the input were directly applied to the root graphical element. Processing may end or continue, such as back to step 212 for processing additional inputs on the same or other graphical elements. Step 214 then determines the root graphical element that is the target of the user input.

In another embodiment, the computer code and inputs are recorded to create a test script. The test script may be replayed on a second AUT (e.g., a different computer, different operating system, etc.) or on the same AUT to test one or more operations of the AUT. The test script may be replayed as recorded or modified (e.g., change the values of text inputs, select different options, etc.). The results of the replayed test script may then evaluate the behavior of the AUT on the same or other AUT.

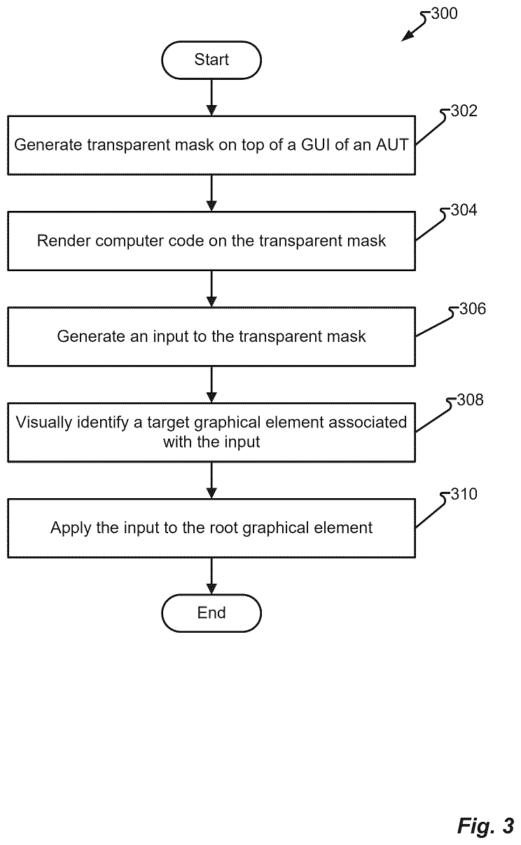

FIG. 3 depicts a process in accordance with embodiments of the present disclosure. In one embodiment, process 300 is embodied as machine-readable instructions maintained in a non-transitory memory that when read by a machine, such as one or more microprocessors of a server or servers, cause the machine to execute the instructions and thereby execute process 300. The processor of the server may include, but is not limited to, at least one microprocessor of server 110.

Process 300 begins and, in step 302, a transparent mask is generated with computer code to imitate one or more graphical elements. Step 302 may generate the mask in accordance with recorded information, such as a test script, obtained from an AUT to identify root graphical elements (see FIG. 2). Step 304, which may be combined with step 302, renders computer code, such as computer code generated (see Step 206, FIG. 2) and maintained in a data storage. Step 306 generates a user input (e.g., a keyboard input, mouse/touch screen movement or click, etc.). Step 308 then visually identifies a target graphical element associated with the input. For example, a mouse click on the transparent layer may correspond with a particular graphical element (e.g., a button, game character, etc.). Step 310 then applies the input to the root graphical element.

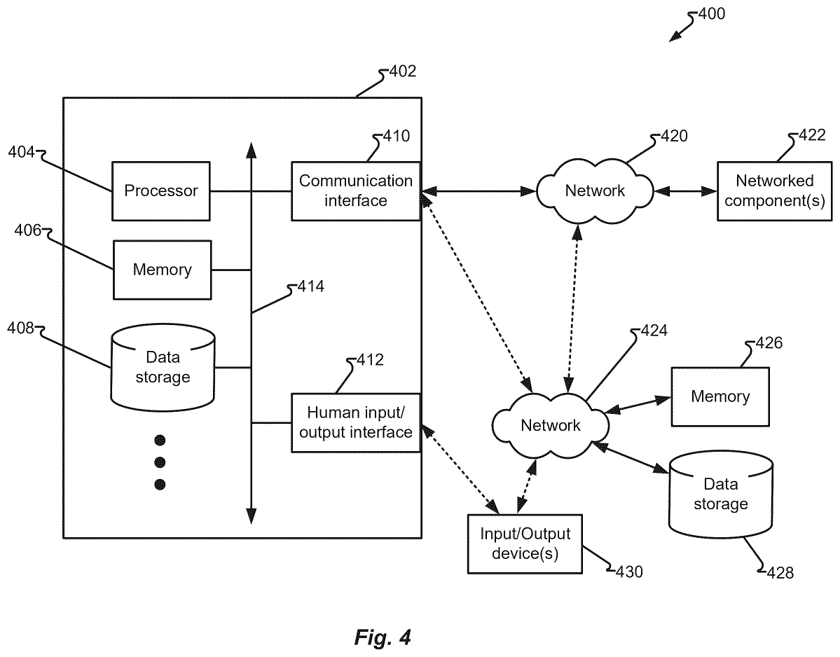

FIG. 4 depicts device 402 in system 400 in accordance with embodiments of the present disclosure. In one embodiment, computer 102 and/or server 110 may be embodied, in whole or in part, as device 402 comprising various components and connections to other components and/or systems. The components are variously embodied and may comprise processor 404. The term “processor,” as used herein, refers exclusively to electronic hardware components comprising electrical circuitry with connections (e.g., pin-outs) to convey encoded electrical signals to and from the electrical circuitry. Processor 404 may comprise programmable logic functionality, such as determined, at least in part, from accessing machine-readable instructions maintained in a non-transitory data storage, which may be embodied as circuitry, on-chip read-only memory, computer memory 406, data storage 408, etc., that cause the processor 404 to perform the steps of the instructions. Processor 404 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 414, executes instructions, and outputs data, again such as via bus 414. In other embodiments, processor 404 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 404 is a non-transitory computing device (e.g., electronic machine comprising circuitry and connections to communicate with other components and devices). Processor 404 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 404). Processor 404 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 404, device 402 may utilize computer memory 406 and/or data storage 408 for the storage of accessible data, such as instructions, values, etc. Communication interface 410 facilitates communication with components, such as processor 404 via bus 414 with components not accessible via bus 414 and may be embodied as a network interface (e.g., ethernet card, wireless networking components, USB port, etc.). Communication interface 410 may be embodied as a network port, card, cable, or other configured hardware device. Additionally or alternatively, human input/output interface 412 connects to one or more interface components to receive and/or present information (e.g., instructions, data, values, etc.) to and/or from a human and/or electronic device. Examples of input/output devices 430 that may be connected to input/output interface include, but are not limited to, keyboard, mouse, trackball, printers, displays, sensor, switch, relay, speaker, microphone, still and/or video camera, etc. In another embodiment, communication interface 410 may comprise, or be comprised by, human input/output interface 412. Communication interface 410 may be configured to communicate directly with a networked component or configured to utilize one or more networks, such as network 420 and/or network 424.

Network 108 may be embodied, in whole or in part, as network 420. Network 420 may be a wired network (e.g., Ethernet), wireless (e.g., WiFi, Bluetooth, cellular, etc.) network, or combination thereof and enable device 402 to communicate with networked component(s) 422. In other embodiments, network 420 may be embodied, in whole or in part, as a telephony network (e.g., public switched telephone network (PSTN), private branch exchange (PBX), cellular telephony network, etc.).

Additionally or alternatively, one or more other networks may be utilized. For example, network 424 may represent a second network, which may facilitate communication with components utilized by device 402. For example, network 424 may be an internal network to a business entity or other organization, whereby components are trusted (or at least more so) than networked components 422, which may be connected to network 420 comprising a public network (e.g., Internet) that may not be as trusted.

Components attached to network 424 may include computer memory 426, data storage 428, input/output device(s) 430, and/or other components that may be accessible to processor 404. For example, computer memory 426 and/or data storage 428 may supplement or supplant computer memory 406 and/or data storage 408 entirely or for a particular task or purpose. As another example, computer memory 426 and/or data storage 428 may be an external data repository (e.g., server farm, array, “cloud,” etc.) and enable device 402, and/or other devices, to access data thereon. Similarly, input/output device(s) 430 may be accessed by processor 404 via human input/output interface 412 and/or via communication interface 410 either directly, via network 424, via network 420 alone (not shown), or via networks 424 and 420. Each of computer memory 406, data storage 408, computer memory 426, data storage 428 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 430 may be a router, a switch, a port, or other communication component such that a particular output of processor 404 enables (or disables) input/output device 430, which may be associated with network 420 and/or network 424, to allow (or disallow) communications between two or more nodes on network 420 and/or network 424. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users'premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A method, comprising:
accessing an application, the application comprising a graphical user interface (GUI) comprising a plurality of graphical elements;
capturing an image of the GUI;
visually identifying each of the plurality of graphical elements of the GUI;
converting the image into computer code to imitate each of the plurality of graphical elements;
generating a first transparent mask over the GUI;
rendering the computer code on the first transparent mask;
receiving an input to the first transparent mask; and
determining a root graphical element associated with a first graphical element corresponding to one of the plurality of graphical elements co-located with the first input.

2. The method of claim 1, further comprising:
rendering the computer code comprising a second transparent mask;
receiving a second input to the second transparent mask;
generating an event corresponding to the second input to the second transparent mask; and
visually identifying a target graphical element associated with the one of the plurality of graphical elements co-located with the second input.

3. The method of claim 2, further comprising providing the target graphical element with the event corresponding to the second input to the second transparent mask.

4. The method of claim 1, wherein:
visually identifying each of the plurality of graphical elements further comprises identifying a plurality of sub-elements comprising at least one of the plurality of graphical elements; and
determining the root graphical element associated with the one of the plurality of graphical elements co-located with the first input, further comprises, determining a sub-root graphical element associated with the one of the plurality of sub-elements.

5. The method of claim 1, wherein the identifying the plurality of graphical elements comprises providing the GUI to a neural network trained to identify graphical elements and receiving, therefrom, a description of the plurality of graphical elements.

6. The method of claim 5, further comprising providing at least one attribute of the first input to the neural network.

7. The method of claim 1, wherein the computer code comprises a hypertext markup language (HTML) code snippet.

8. The method of claim 1, wherein the application comprises a web browser configured with instructions to present the GUI.

9. The method of claim 1, further comprising generating a test script comprising at least one test input corresponding to the first input to the one of the plurality of graphical elements co-located with the first input.

10. The method of claim 9, wherein generating the test script further comprises generating the at least one test input comprising a modification, the modification comprising at least one of generating the at least one test input to differ from the first input, generating the at least one test input to be applied to a second one of the plurality of graphical elements co-located with the first input, or generating an additional test input to be performed before or after the test input.

11. A system, comprising:
a microprocessor coupled to instructions maintained in a non-transitory memory that, when read by the microprocessor, cause the microprocessor to perform:
accessing an application, the application comprising a graphical user interface (GUI) comprising a plurality of graphical elements;
capturing an image of the GUI;
visually identifying each of the plurality of graphical elements;
converting the image into computer code to imitate each of the plurality of graphical elements;
generating a first transparent mask to the GUI;
rendering the computer code on the first transparent mask;
receiving an input to the first transparent mask; and
determining a root graphical element associated with a first graphical element corresponding to one of the plurality of graphical elements co-located with the first input.

12. The system of claim 11, further comprising instructions to cause the microprocessor to perform:
rendering the computer code comprising a second transparent mask;
receiving a second input to the second transparent mask;
generating an event corresponding to the second input to the second transparent mask; and
visually identifying a target graphical element associated with the one of the plurality of graphical elements co-located with the second input.

13. The system of claim 12, further comprising instructions to cause the microprocessor to perform providing the target graphical element with the event corresponding to the second input to the second transparent mask.

14. The system of claim 11, further comprising instructions to cause the microprocessor to perform:
visually identifying each of the plurality of graphical elements further comprising identifying a plurality of sub-elements comprising at least one of the plurality of graphical elements; and
determining the root graphical element associated with the one of the plurality of graphical elements co-located with the first input, further comprises, determining a sub-root graphical element associated with the one of the plurality of sub-elements.

15. The system of claim 11, wherein the instructions to cause the microprocessor to perform identifying the plurality of graphical elements further comprises instructions to cause the microprocessor to perform providing the GUI to a neural network trained to identify graphical elements and receiving, therefrom, a description of the plurality of graphical elements.

16. The system of claim 15, further comprising instructions to cause the microprocessor to perform providing at least one attribute of the first input to the neural network.

17. The system of claim 11, wherein the computer code comprises a hypertext markup language (HTML) code snippet.

18. The system of claim 11, wherein the application comprises a web browser configured with instructions to present the GUI.

19. The system of claim 11, further comprising instructions to cause the microprocessor to perform generating a test script comprising at least one test input corresponding to the first input to the one of the plurality of graphical elements co-located with the first input.

20. An apparatus, comprising:
a network interface to a network;
a storage device; and
at least one microprocessor, each of the at least one microprocessor coupled to a non-transitory memory comprising instructions that, when read by the at least one microprocessor, cause at least a portion of the at least one microprocessor to perform:
executing an application, the application comprising a graphical user interface (GUI) comprising a plurality of graphical elements;
capturing an image of the GUI;
visually identifying each of the plurality of graphical elements;
converting the image into computer code to imitate each of the plurality of graphical elements;
generating a first transparent mask to the GUI;
rendering the computer code on the first transparent mask;
receiving an input to the first transparent mask;
determining a root graphical element associated with a first graphical element corresponding to one of the plurality of graphical elements co-located with the first input;
generating a test script comprising at least one test input corresponding to the first input to the one of the plurality of graphical elements co-located with the first input; and
providing the test script to at least one of the storage device or a second device via the network interface.
